(19) United States
(12) Patent Application Publication
(10) Pub. No.: US 2025/0386095 A1
(43) Pub. Date: Dec. 18, 2025

(54) REMOTE PHOTOGRAPHING METHOD AND APPARATUS, DEVICE, AND STORAGE MEDIUM

(71) Applicant: Beijing Zitiao Network Technology Co., Ltd., Beijing (CN)

(72) Inventor: Ning ZHANG, Beijing (CN)

(21) Appl. No.: 18/876,179

(22) PCT Filed: Jun. 30, 2023
(86) PCT No.: PCT/CN2023/105211

§ 371 Date: Dec. 17, 2024

(30) Foreign Application Priority Data
Jul. 15, 2022 (CN) 202210836979.0

(51) Int. Cl. H04N 23/661; H04L 61/5069

(52) U.S. Cl. CPC H04N 23/661; H04L 61/5069

(57) ABSTRACT

A remote photographing method and apparatus, an electronic device and a computer-readable storage medium. The remote photographing method includes: receiving, by a first terminal, a remote photographing request used for instructing the first terminal to search for a second terminal, the second terminal being used for sending a photographing instruction to the first terminal; determining, by the first terminal, a host internet protocol address range of the second terminal in a local area network corresponding to a wireless network or a hotspot accessed by the first terminal in response to multicast of the local area network being abnormal; and sending, by the first terminal, a unicast message to the second terminal according to the host internet protocol address range of the second terminal, the unicast message being used for requesting acquisition of information of the second terminal in the local area network.

### CROSS-REFERENCE TO RELATED APPLICATION

The present application claims priority to and benefits of Chinese Patent Application No. 202210836979.0, filed on Jul. 15, 2022, entitled “REMOTE PHOTOGRAPHING METHOD AND APPARATUS, DEVICE, AND STORAGE MEDIUM”, which is incorporated in its entirety by reference in the present application.

### TECHNICAL FIELD

The present disclosure relates to the field of information interaction technology, and in particular, to a remote photographing method, apparatus, electronic device, computer-readable storage medium, computer program product, and computer program.

### BACKGROUND

In daily life, users often use a photographing terminal to take a selfie or let others assist in photographing. However, in some cases, when the user adjusts the attitude of the photographing terminal, it may be inconvenient to perform photographing. In this case, it is necessary to share the photographing screen of the photographing terminal to a remote control terminal so that the remote control terminal can control the photographing terminal to perform remote photographing.

In the related art, the remote control terminal may be discovered through user datagram protocol (UDP) broadcasting in a local area network corresponding to a wireless network or a hotspot accessed by the photographing terminal, thereby transmitting a video preview frame and delivering a photographing instruction through transmission control protocol (TCP) after connecting the photographing terminal and the remote control terminal.

However, receiving relevant data entirely through UDP broadcasting increases the router workload, and because some routers restrict UDP broadcasting or multicasting, it cannot guarantee that the photographing terminal and the remote control terminal establish a remote photographing connection.

### SUMMARY

The present disclosure provides a remote photographing method, apparatus, electronic device, computer-readable storage medium, computer program product, and computer program.

In a first aspect, an embodiment of the present disclosure provides a remote photographing method, including:
receiving, by a first terminal, a remote photographing request used for instructing the first terminal to search for a second terminal, the second terminal being used for sending a photographing instruction to the first terminal;
determining, by the first terminal, a host internet protocol address range of the second terminal in a local area network corresponding to a wireless network or a hotspot accessed by the first terminal in response to multicast of the local area network being abnormal; and
sending, by the first terminal, a unicast message to the second terminal according to the host internet protocol address range of the second terminal, the unicast message being used for requesting acquisition of information of the second terminal in the local area network.

In a second aspect, an embodiment of the present disclosure provides a remote photographing apparatus, including:
a receiving module, for a first terminal to receive a remote photographing request used for instructing the first terminal to search for a second terminal, the second terminal being used for sending a photographing instruction to the first terminal;
a processing module, configured to determine a host internet protocol address range of the second terminal in a local area network corresponding to a wireless network or a hotspot accessed by the first terminal in response to multicast of the local area network being abnormal; and
a sending module, configured to send a unicast message to the second terminal according to the host internet protocol address range of the second terminal, the unicast message being used for requesting acquisition of information of the second terminal in the local area network.

In a third aspect, an embodiment of the present disclosure provides an electronic device, including:
a processor; and
a memory for storing a computer program;
where the processor is configured to, when executing the computer program, implement the remote photographing method as described above in the first aspect and various possible designs of the first aspect.

In a fourth aspect, an embodiment of the present disclosure provides a computer-readable storage medium storing computer execution instructions, where when the computer execution instructions are executed by a processor, the remote photographing method as described above in the first aspect and various possible designs of the first aspect is implemented.

In a fifth aspect, an embodiment of the present disclosure provides a computer program product including a computer program, where when the computer program is executed by a processor, the remote photographing method as described above in the first aspect and various possible designs of the first aspect is implemented.

In a sixth aspect, an embodiment of the present disclosure provides a computer program, where when the computer program is executed by a processor, the remote photographing method as described above in the first aspect and various possible designs of the first aspect is implemented.

### BRIEF DESCRIPTION OF DRAWINGS

In order to more clearly illustrate the technical solutions in the embodiments of the present disclosure or the prior art, the following will simply introduce the accompanying drawings which are required to be used in the description of the embodiments or the prior art, it is obvious that the accompanying drawings in the following description are some embodiments of the present disclosure, and other drawings may be obtained according to these drawings for those of ordinary skill in the art without paying inventive step.

FIG. 1 is a schematic diagram of an application scenario of a remote photographing method provided by an embodiment of the present application.

FIG. 2 is a flowchart schematic diagram of a remote photographing method provided by an embodiment of the present disclosure.

FIG. 3 is a flowchart schematic diagram of another remote photographing method provided by an embodiment of the present disclosure.

FIG. 4 is a flowchart schematic diagram of still another remote photographing method provided by an embodiment of the present disclosure.

FIG. 5 is a structural block diagram of a remote photographing apparatus according to an embodiment of the present disclosure.

FIG. 6 illustrates a structural diagram of an electronic device according to an example embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as limited to the embodiments set forth here. On the contrary, these embodiments are provided for a more thorough and complete understanding of the present disclosure. It should be understood that the drawings and embodiments of the disclosure are only for illustrative purposes, and are not intended to limit the protection scope of the disclosure.

It should be understood that the steps described in the method embodiments of the present disclosure may be performed in different order and/or in parallel. In addition, the method embodiments may include additional steps and/or omit the steps shown. The scope of the present disclosure is not limited in this respect.

As used herein, the term “including” and its variations are open including, that is, “including but not limited to”. The term “based on” means “at least partially based on”. The term “one embodiment” means “at least one embodiment”; the term “another embodiment” means “at least one other embodiment”; the term “some embodiments” means “at least some embodiments”. Relevant definitions of other terms will be given in the following description.

It should be noted that the modification “one” and “a plurality” mentioned in this disclosure are illustrative rather than restrictive, and those skilled in the art should understand that unless the context clearly indicates otherwise, they should be understood as “one or more”.

In daily life, users often use a photographing terminal to take a selfie or let others assist in photographing. However, in some cases, when the user adjusts the attitude of the photographing terminal, it may be inconvenient to perform photographing. In this case, it is necessary to share the photographing screen of the photographing terminal to a remote control terminal so that the remote control terminal can control the photographing terminal to perform remote photographing.

In the related art, the remote control terminal may be discovered through UDP broadcasting in a local area network corresponding to a wireless network or a hotspot accessed by the photographing terminal, thereby transmitting a video preview frame and delivering a photographing instruction through TCP after connecting the photographing terminal and the remote control terminal. However, receiving relevant data entirely through UDP broadcasting increases the router workload, and because some routers restrict UDP broadcasting or multicasting, it cannot guarantee that the photographing terminal and the remote control terminal establish a remote photographing connection.

To solve the above problem, embodiments of the present disclosure provide a remote photographing method, apparatus, device, and storage medium that, when multicast is abnormal, traverse sending a unicast message to a second terminal in a local area network by determining a host internet protocol address range of the second terminal in the local area network, thereby guaranteeing that a photographing terminal and a remote control terminal establish a remote photographing connection.

The following is explained for an application scenario of the remote photographing method to which the present application relates.

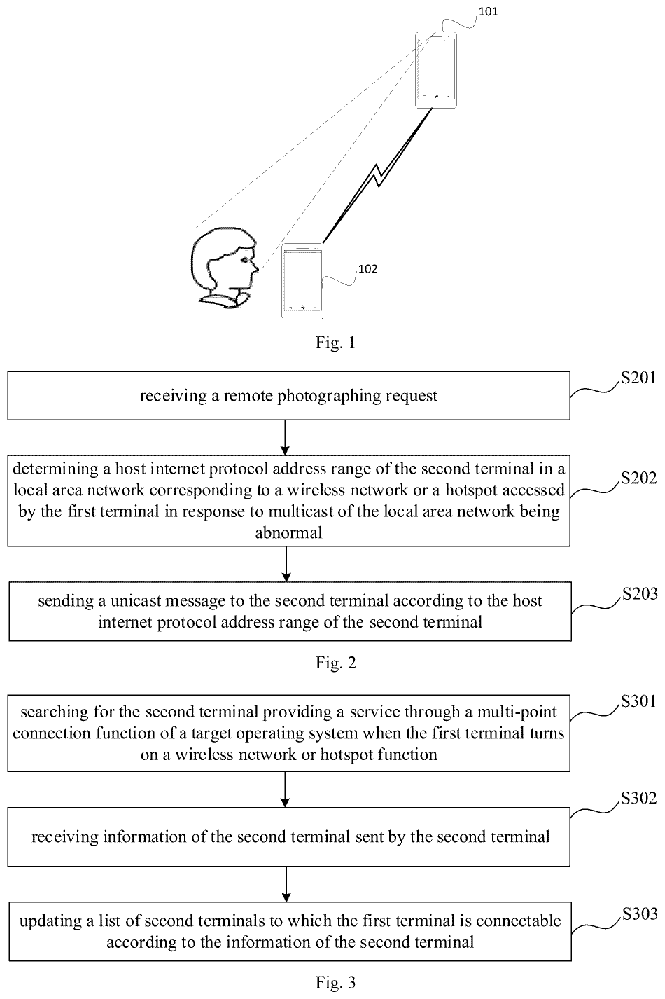

FIG. 1 is a schematic diagram of an application scenario of a remote photographing method provided by an embodiment of the present application. As shown in FIG. 1, before a user uses the photographing terminal 101 to perform photographing, the user may search for the remote control terminal 102 in the local area network corresponding to the wireless network or the hotspot accessed by the photographing terminal 101, thereby sharing the photographing screen of the photographing terminal 101 to the remote control terminal 102 and controlling the photographing terminal 101 to perform remote photographing by the remote control terminal 102. When the photographing terminal 101 searches for the remote control terminal 102, a remote photographing connection may be established between the remote control terminal 102 and the photographing terminal 101, and then, a photographing instruction may be sent to the photographing terminal 101 by the remote control terminal 102.

Where the photographing terminal 101 is a terminal having a photographing function, the photographing terminal 101 and the remote control terminal 102 may each be a Portable Android Device (PAD), a computer with a wireless transmission and reception function, a Virtual Reality (VR) terminal device, an Augmented Reality (AR) terminal device, a wireless terminal in Industrial Control, a wireless terminal in Self-Driving, a wireless terminal in Remote Medical Surgery, a wireless terminal in Smart Grid, a wireless terminal in Smart Home, or the like. In the embodiment of the present application, the apparatus for implementing the function of the terminal may be the terminal, or may be an apparatus capable of supporting the terminal to implement the function, such as a chip system, and the apparatus may be installed in the terminal. In embodiments of the present application, the chip system may be formed of chips or may include chips and other discrete components.

It should be understood that the application scenario of the technical solution of the present application may be the scenario in FIG. 1, but the present application is not limited thereto, and the technical solution of the present application may also be applied in other scenarios requiring remote photographing.

It can be understood that the above remote photographing method may be implemented by the remote photographing apparatus provided by the embodiments of the present application, and the remote photographing apparatus may be part or all of a certain device, for example, a terminal device or a processor of the terminal device.

The technical solutions of the embodiments of the present disclosure are explained in detail below with specific embodiments. The following several specific embodiments may be combined with each other, and the same or similar concepts or processes may not be repeated in some embodiments.

Referring to FIG. 2, FIG. 2 is a flowchart schematic diagram of a remote photographing method provided by an embodiment of the present disclosure. The subject of execution of the present embodiment is the first terminal, and the present embodiment relates to the process of how the first terminal searches for a second terminal as the remote control terminal. The remote photographing method includes:

S201, receiving, by a first terminal, a remote photographing request used for instructing the first terminal to search for a second terminal, the second terminal being used for sending a photographing instruction to the first terminal.

In the present disclosure, before the user uses the first terminal for remote photographing, the user may input a remote photographing request to the first terminal, thereby causing the first terminal to search for a second terminal as the remote control terminal.

It should be understood that the first terminal described above may be a photographing terminal used for photographing, for example, a cell phone, a tablet computer, a camera, or the like. The second terminal is a remote control terminal that shares the photographing screen of the first terminal and sends a photographing instruction to the first terminal, for example, a smart watch, a cell phone, a remote controller, and the like.

It should be understood that the embodiments of the present application do not limit how to input the remote photographing request to the first terminal, and in some embodiments, the user may input the remote photographing request to the first terminal by triggering a corresponding control on the first terminal.

S202, determining, by the first terminal, a host internet protocol address range of the second terminal in a local area network corresponding to a wireless network or a hotspot accessed by the first terminal in response to multicast of the local area network being abnormal.

In the present disclosure, when the first terminal receives the remote photographing request input by the user, first attempts to search for the second terminal using multicast, and when the multicast in a local area network corresponding to a wireless network or a hotspot accessed by the first terminal is abnormal, a host internet protocol (IP) range of the second terminal is determined in the local area network.

It should be understood that embodiments of the present application are not limited to the type of multicast described above, and in some embodiments, the multicast described above may be UDP multicast.

Where the wireless network or the hotspot may include WiFi, cell phone hotspot, in-vehicle hotspot, and the like.

In some embodiments, the first terminal may first determine whether the first terminal accesses a wireless network or a hotspot, and if the first terminal does not access the wireless network or the hotspot, prompt information may be displayed on a display interface of the first terminal, in which the prompt information is used to prompt the user to access the first terminal to the wireless network or the hotspot. If the first terminal accesses the wireless network or hotspot, the first terminal joins the multicast and starts listening to the multicast. Subsequently, the first terminal may determine whether the multicast is normally turned on. If the multicast is normal, the first terminal sends a multicast message to the second terminal in the local area network, in which the multicast message is used to request acquisition of information of the second terminal in the local area network. If the multicast is abnormal, a host internet protocol address range of the second terminal is determined in the local area network.

In embodiments of the present application, there is no limitation on how to confirm whether the multicast is normally turned on, and in some embodiments, it may be determined by whether the first terminal receives the feedback message sent by the second terminal within a preset duration after sending the multicast. Illustratively, the preset duration may be 3 seconds. If the first terminal receives the feedback message sent by at least one second terminal within 3 seconds after sending the multicast, it is determined that the multicast is normal. If the first terminal does not receive the feedback message sent by at least one second terminal within 3 seconds after sending the multicast, it is determined that the multicast is abnormal.

In the present disclosure, the first terminal first searches for the second terminal using the multicast. By using the multicast instead of the broadcast, the terminals receiving data in the process of searching for the second terminal can be reduced, so that the workload of the router can be reduced.

It should be understood that embodiments of the present application also do not limit how to determine the host internet protocol address range of the second terminal, and in some embodiments, the host internet protocol address range of the second terminal may be determined according to the local internet protocol address and the subnet mask in the local area network.

S203, sending, by the first terminal, a unicast message to the second terminal according to the host internet protocol address range of the second terminal, the unicast message being used for requesting acquisition of information of the second terminal in the local area network.

In this step, after the first terminal determines the internet protocol address range of the second terminal in the local area network, the first terminal may traverse sending a unicast message to the second terminal according to the host internet protocol address range of the second terminal, thereby acquiring the information of the second terminal.

In some embodiments, after receiving the unicast message, the second terminal may send a feedback message to the first terminal, in which the feedback message includes information of the second terminal. Subsequently, the first terminal updates a list of second terminals to which the first terminal is connectable based on the feedback message.

In some embodiments, the first terminal may display a list of connectable second terminals in order for the user to select the second terminal used to establish the remote photographing connection. When the user selects an appropriate second terminal, an instruction message may be input to the first terminal so that the first terminal establishes a remote photographing connection with the selected second terminal.

Where the remote photographing connection is used for sharing a photographing screen of the first terminal to the second terminal and sending a photographing instruction to the first terminal through the second terminal.

In other embodiments, the first terminal may determine failure to send the unicast message if the feedback message sent by the second terminal is not received within a preset duration, and at this time, the first terminal may generate a two-dimensional code according to the local internet protocol address of the first terminal and display the two-dimensional code. The user may scan the two-dimensional code directly using the second terminal, thereby causing the second terminal to acquire the local internet protocol address of the first terminal, so as to establish a remote photographing connection between the first terminal and the second terminal. It should be noted that the present embodiments do not limit the length of the preset duration, and in some embodiments, the preset duration may be 5 seconds, 10 seconds, 30 seconds, or the like.

In the present disclosure, when the multicast is abnormal, the remote photographing connection between the first terminal and the second terminal may be directly established by the manner of sending a unicast message or the manner of generating and scanning a two-dimensional code, thereby improving the success rate of establishing the remote photographing connection.

The remote photographing method provided by an embodiment of the present disclosure, the first terminal first receives a remote photographing request, the remote photographing request is used for instructing the first terminal to search for the second terminal, and the second terminal is used for sending a photographing instruction to the first terminal. Subsequently, when the multicast of the local area network corresponding to the wireless network or the hotspot to which the first terminal accesses is abnormal, the first terminal determines the host internet protocol address range of the second terminal in the local area network. Finally, the first terminal sends a unicast message to the second terminal according to the host internet protocol address range of the second terminal, in which the unicast message is used for requesting acquisition of information of the second terminal in the local area network. By this means, when the multicast is abnormal, the host internet protocol address range of the second terminal can be determined in the local area network, so as to traverse sending a unicast message to the second terminal in the local area network, which can ensure that the first terminal for photographing and the second terminal for remote control establish a remote shooting connection.

On the basis of the above embodiment, if the first terminal and the second terminal are specific target operating systems, it is possible to directly search for the second terminal providing the service using the multi-point connection function of the target operating system. FIG. 3 is a flowchart schematic diagram of another remote photographing method provided by an embodiment of the present disclosure, and as shown in FIG. 3, the remote photographing method includes:

S301, searching, by the first terminal, for the second terminal providing a service through a multi-point connection function of a target operating system when the first terminal turns on a wireless network or hotspot function.

Where the wireless network or hotspot function may be a WiFi function, a hotspot function, or the like.

It should be understood that the embodiment of the present disclosure is not limited to target operating system, such as IOS system, Android system, and the like. For example, if the target operating system is an IOS system, the second terminal may be searched directly using WiFi Direct through the multi-point connection function, simply turn on the WiFi function without connecting to WiFi, and the remote photographing connection between the first terminal and the second terminal can be established more quickly.

S302, receiving, by the first terminal, information of the second terminal sent by the second terminal.

Where the information of the second terminal is carried in a unicast message, a multicast message or an additional message of the multi-point connection function.

S303, updating, by the first terminal, a list of second terminals to which the first terminal is connectable according to the information of the second terminal.

In some embodiments, the first terminal may search for the second terminal not only by sending multicast information, unicast message, but also by using the multi-point connection function of the target operating system. Accordingly, in order to distinguish when updating the list of second terminals to which the first terminal is connectable, the list of second terminals to which the first terminal is connectable includes indication information for indicating the operating system of the second terminal.

For example, the indication information in the above list of second terminals to which the first terminal is connectable may indicate information of dimensions of each second terminal, and may include the name of the second terminal, the name of the operating system. When the operating system is an IOS system, the indication information may further include the name of the IOS device.

Where the name of the operating system may indicate type information of the operating system. For example, if the character of a particular position in the name of the operating system is 1, the operating system may be an IOS system, and if the character of a particular position in the name of the operating system is 2, the operating system may be an Android system.

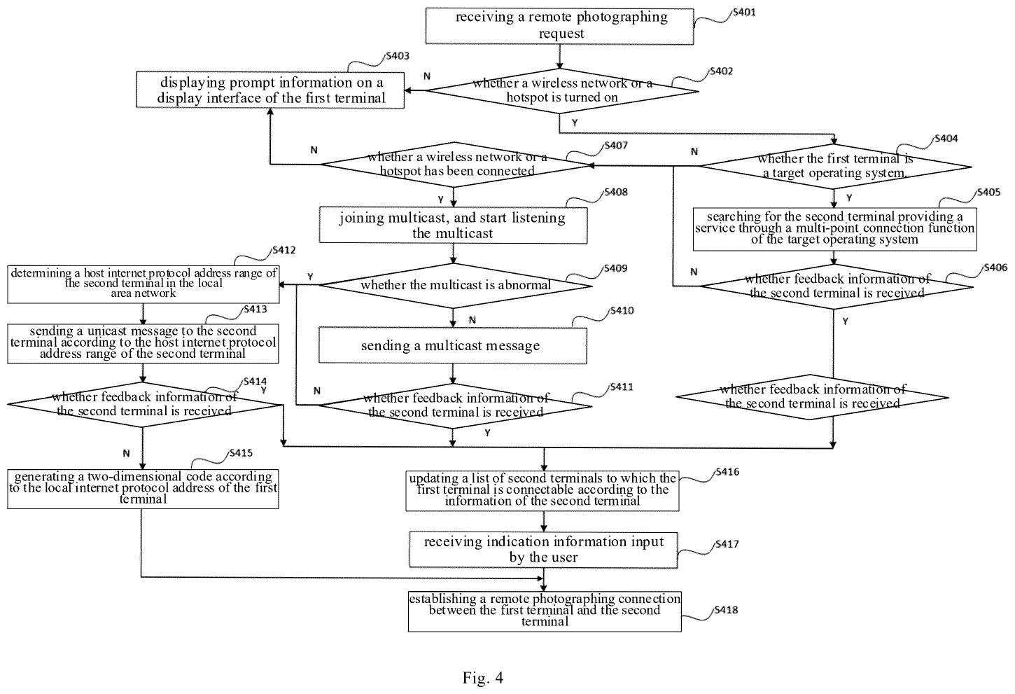

On the basis of the above embodiments, a completed remote photographing method is provided below. FIG. 4 is a flowchart schematic diagram of still another remote photographing method provided by an embodiment of the present disclosure, and as shown in FIG. 4, the remote photographing method includes:

S401, receiving a remote photographing request, the remote photographing request being used for instructing a first terminal to search for a second terminal, the second terminal being used for sending a photographing instruction to the first terminal.

S402, determining whether a wireless network or a hotspot is turned on.

If yes, step S404 is performed, and if no, step S403 is performed.

S403, displaying prompt information on a display interface of the first terminal.

S404, determining whether the first terminal is a target operating system.

If yes, step S405 is performed, and if no, step S407 is performed.

S405, searching for a second terminal providing the service through a multi-point connection function of the target operating system.

S406, determining whether feedback information of the second terminal is received.

If yes, step S416 is performed, and if no, step S407 is performed.

S407, determining whether a wireless network or a hotspot has been connected.

If yes, step S408 is performed, and if no, step S403 is performed.

S408, joining multicast, and start listening the multicast.

S409, determining whether the multicast is abnormal.

If yes, step S412 is performed, and if no, step S410 is performed.

S410, sending a multicast message.

S411, determining whether feedback information of the second terminal is received.

If yes, step S416 is performed, and if no, step S412 is performed.

S412, determining a host internet protocol address range of the second terminal in the local area network.

S413, sending a unicast message to the second terminal according to the host internet protocol address range of the second terminal.

S414, determining whether feedback information of the second terminal is received.

If yes, step S416 is performed, and if no, step S415 is performed.

S415, generating a two-dimensional code according to the local internet protocol address of the first terminal.

After step S415, step S418 is performed.

S416, updating a list of second terminals to which the first terminal is connectable according to the information of the second terminal.

S417, receiving indication information input by the user, the indication information being used for indicating a second terminal selected from the list of second terminals.

S418, establishing a remote photographing connection between the first terminal and the second terminal.

The remote photographing method provided by an embodiment of the present disclosure, the first terminal first receives a remote photographing request, the remote photographing request is used for instructing the first terminal to search for the second terminal, and the second terminal is used for sending a photographing instruction to the first terminal. Subsequently, when the multicast of the local area network corresponding to the wireless network or the hotspot to which the first terminal accesses is abnormal, the first terminal determines the host internet protocol address range of the second terminal in the local area network. Finally, the first terminal sends a unicast message to the second terminal according to the host internet protocol address range of the second terminal, in which the unicast message is used for requesting acquisition of information of the second terminal in the local area network. By this means, when the multicast is abnormal, the host internet protocol address range of the second terminal can be determined in the local area network, so as to traverse sending a unicast message to the second terminal in the local area network, which can ensure that the first terminal for photographing and the second terminal for remote control establish a remote shooting connection.

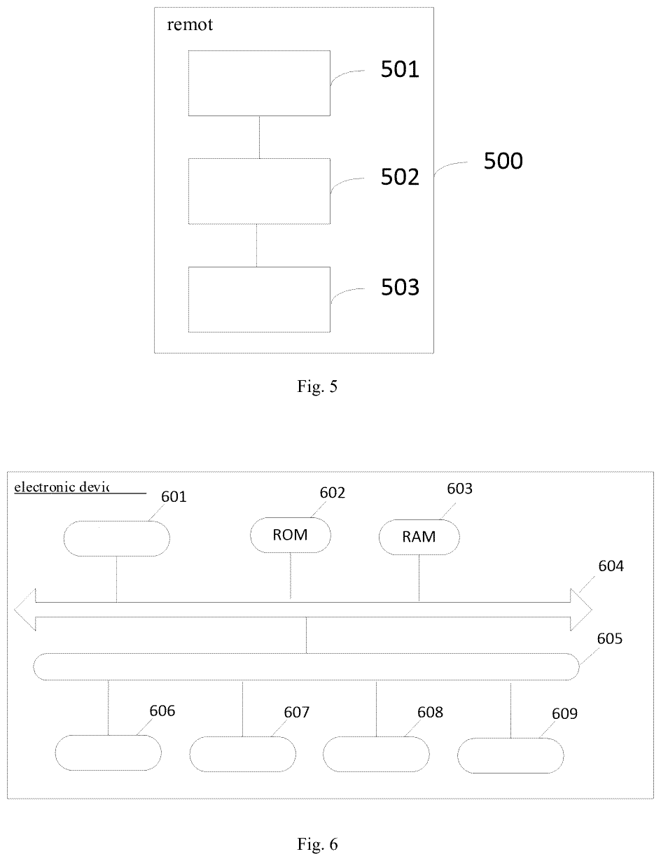

Corresponding to the remote photographing method of the above embodiment, FIG. 5 is a structural block diagram of a remote photographing apparatus provided by an embodiment of the present disclosure. For convenience of explanation, only parts related to the embodiment of the present disclosure are shown. Referring to FIG. 5, the remote photographing apparatus 500 includes a receiving module 501, a processing module 502, and a sending module 503.

The receiving module 501 is configured for a first terminal to receive a remote photographing request used for instructing the first terminal to search for a second terminal, the second terminal being used for sending a photographing instruction to the first terminal.

The processing module 502 is configured to determine a host internet protocol address range of the second terminal in a local area network corresponding to a wireless network or a hotspot accessed by the first terminal in response to multicast of the local area network being abnormal.

The sending module 503 is configured to send a unicast message to the second terminal according to the host internet protocol address range of the second terminal, the unicast message being used for requesting acquisition of information of the second terminal in the local area network.

According to one or more embodiments of the present disclosure, the processing module 502 is further configured to determine the host internet protocol address range of the second terminal according to a local internet protocol address and a subnet mask in the local area network.

According to one or more embodiments of the present disclosure, the receiving module 501 is further configured to receive a feedback message transmitted by the second terminal, the feedback message including information of the second terminal;

The processing module 502 is further configured to update a list of second terminals to which the first terminal is connectable according to the feedback message.

According to one or more embodiments of the present disclosure, the processing module 502 is further configured to select, from the list of second terminals, the second terminal that establishes a remote photographing connection with the first terminal according to indication information input by a user, the remote photographing connection being used for sharing a photographing screen of the first terminal to the second terminal and sending the photographing instruction input by the user to the first terminal through the second terminal.

According to one or more embodiments of the present disclosure, the processing module 502 is further configured to, in response to not receiving the feedback message sent by the second terminal within a preset duration, generate a two-dimensional code according to a local internet protocol address of the first terminal, so as to enable the second terminal to establish the remote photographing connection with the first terminal according to the local internet protocol address of the first terminal when scanning the two-dimensional code.

According to one or more embodiments of the present disclosure, the processing module 502 is further configured to join and listen to the multicast, and determine whether the multicast is normally turned on.

The sending module 503 is further configured to, in response to the multicast being normal, send a multicast message to the second terminal in the local area network, the multicast message being used for requesting acquisition of the information of the second terminal in the local area network.

According to one or more embodiments of the present disclosure, the processing module 502 is further configured to determine whether to access the wireless network or the hotspot, and display prompt information on a display interface of the first terminal in response to the first terminal not accessing the wireless network or the hotspot, the prompt information being used for prompting the user to access the first terminal to the wireless network or the hotspot.

According to one or more embodiments of the present disclosure, the processing module 502 is further configured to, in response to the first terminal accessing the wireless network or the hotspot, join and listen to the multicast.

According to one or more embodiments of the present disclosure, the processing module 502 is further configured to search for the second terminal providing a service through a multi-point connection function of a target operating system after the first terminal turns on a wireless network or a hotspot function.

The receiving module 501 is further configured to receive information of the second terminal sent by the second terminal.

The processing module 502 is further configured to update a list of second terminals to which the first terminal is connectable according to the information of the second terminal.

According to one or more embodiments of the present disclosure, the information of the second terminal is carried in a unicast message, a multicast message, or an additional message of the multi-point connection function.

According to one or more embodiments of the present disclosure, the list of second terminals to which the first terminal is connectable includes indication information indicating an operating system of the second terminal.

It should be noted that the remote photographing apparatus according to the embodiment of FIG. 5 may be configured to perform the method according to any one of the above embodiments, and the specific implementation and technical effects thereof are similar, and will not be described in detail herein.

FIG. 6 illustrates a structural diagram of an electronic device according to an example embodiment of the present disclosure. Refer to FIG. 6, which shows the structural schematic diagram of an electronic device 600 for implementing the embodiment of the present disclosure. The electronic device 600 in the embodiment of the present disclosure may include but not limited to mobile terminals with image acquisition function such as mobile phone, laptop, digital radio receiver, personal digital assistant (PDA), portable android device (PAD), portable multimedia player (PMP), car terminal (such as car navigation terminal) and wearable electronic devices and fixed terminals with image acquisition device such as digital TV, desktop computer and smart home devices. The electronic device as shown in FIG. 6 is only an example and should not restrict the functions and the scope of use of the embodiments of the present disclosure.

As shown in FIG. 6, the electronic device 600 may include the processing unit (e.g., a central processor, a graphics processor) 601, which may execute various appropriate actions and processes according to programs stored in the read only memory (ROM) 602 or programs loaded to the random access memory (RAM) 603 from the storage unit 608 to implement the method as described in embodiments of the present disclosure. A plurality of programs and data required for the operation of the electronic device 600 are also stored in the RAM 603. The processing unit 601, the ROM 602 and the RAM 603 are connected with each other through a bus 604. An input/output (I/O) interface 605 is also connected to the bus 604. The memory is used to store programs for executing the various method embodiments described above. The processing unit is configured to execute programs stored in memory to achieve the functions of the embodiments disclosed above and/or other desired functions.

In general, the following units may be connected to the I/O interface 605: an input unit 606 including a touch screen, a touch pad, a keyboard, a mouse, a camera, a microphone, an accelerometer, a gyroscope and the like; an output unit 607 including a liquid crystal display (LCD), a loudspeaker, a vibrator and the like; a storage unit 608 including magnetic tapes and hard disks; and a communication unit 609. The communication unit 609 may allow the electronic device 600 to communicate wirelessly in a wired manner with other devices to exchange data. Although FIG. 6 shows the electronic device 600 including a plurality of units, it should be understood that not all the shown units are required to be implemented or included. More or less units may be implemented alternatively or included.

Particularly, according to the embodiments of the present disclosure, the processes described above with reference to the flowcharts may be implemented as computer software programs. For instance, the embodiment of the present disclosure provides a computer program product, which includes computer programs hosted on a non-transient computer readable medium. The computer programs contain program codes for executing the method as shown in the flowchart of the embodiments of the present disclosure. In the embodiment, the computer programs may be unloaded and installed from the internet through the communication unit 609, or installed from the storage unit 608, or installed from the ROM 602. The above functions defined in the method provided by the embodiment of the present disclosure are executed when the computer programs are executed by the processing unit 601.

It should be noted that the above computer readable medium of the present disclosure may be a computer readable signal medium, a computer readable storage medium, or any combination of the above. The computer readable storage medium, for instance, may be, but not limited to, electrical, magnetic, optical, electromagnetic, infrared, or semiconductor system, device, or equipment, or a combination of the above. A more specific example of the computer readable storage medium may include but not limited to: electrical connection having one or more wires, portable computer disk, hard disk, RAM, ROM, erasable programmable read-only memory (EPROM), flash memory, optical fiber, portable compact disk read-only memory (CD-ROM), optical storage unit, magnetic storage unit, or any suitable combination of the above. In the present disclosure, the computer readable storage medium may be any tangible medium containing or storing programs. The programs may be used by a command execution system, device or unit or used in combination with the command execution system, device or unit. However, in the present disclosure, the computer readable signal medium may include data signals propagated in baseband or as part of carrier, where computer readable program codes are hosted. The propagated data signals may adopt a plurality of forms, including but not limited to electromagnetic signals, optical signals or any suitable combination of the above. The computer readable signal medium may also be any computer readable medium except the computer readable storage medium. The computer readable signal medium can send, propagate or transmit programs used by the command execution system, device or unit or used in combination with the command execution system, device or unit. The program codes contained in the computer readable medium can be transmitted by any appropriate medium, including but not limited to: wire, optical cable, radio frequency (RF) and the like, or any suitable combination of the above.

The above computer readable medium may be contained in the above electronic device and may also exist alone and not be assembled into the electronic device.

The above computer readable medium hosts one or more programs. When the above one or more programs are executed by the electronic device, causing the electronic device to execute the above method.

Computer program codes for performing the operations of the present disclosure may be written in one or more programming languages or a combination thereof. The above programming languages include but not limited to object-oriented programming languages such as Java, Smalltalk and C++, and also include conventional procedural programming languages such as “C” language or similar programming languages. The program codes may be completely executed on a user computer, partially executed on the user computer, executed as a separate package, partially executed on the user computer and partially executed on a remote computer, or completely executed on the remote computer or the server. In the case when the remote computer is involved, the remote computer may be connected to the user computer through any kind of network including local area network (LAN) or wide area network (WAN), or can be connected to an external computer (for instance, connected via the internet by utilization of internet service providers).

In some embodiments, the client and the server may communicate by utilization of any network protocol which is currently known or developed in the future such as hypertext transfer protocol (HTTP), and may be interconnected with digital data communication (e.g., communication network) in any form or medium. The example of the communication network includes LAN, WAN, internet, end-to-end network (e.g., ad hoc end-to-end network), and any network which is current known or developed in the future.

The flowcharts and the block diagrams in the drawings show possible architectures, functions and operations of the system, the method and the computer program product according to the embodiments of the present disclosure. In this regard, each block in the flowchart or the block diagram may represent a module, a program segment, or a part of code. The module, the program segment, or the part of the code contains one or more executable instructions for implementing specified logic functions. It should be also noted that in some alternative implementations, the functions marked in the blocks may also occur in a different order from those marked in the drawings. For instance, two consecutive blocks may actually be executed basically in parallel, and sometimes, may also be executed in a reverse order, determined by involved functions. It should be also noted that each block in the block diagram and/or the flowchart and the combination of the blocks in the block diagram and/or the flowchart may be implemented by a dedicated hardware-based system that performs a specified function or operation, and may also be implemented by the combination of a special hardware and computer instructions.

Modules involved in the embodiments of the present disclosure may be implemented by software, and may also be implemented by hardware. Where the name of the module should not define the unit under certain circumstances.

The functions described above in this document may be at least partially executed by one or more hardware logical units. For example, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

In the context of the present disclosure, the machine readable medium may be a tangible medium and may include or store programs used by command execution system, device or equipment or used in combination with the command execution system, device or equipment. The machine readable medium may be a machine readable signal medium or a machine readable storage medium. The machine readable medium may include but not limited to electronic, magnetic, optical, electromagnetic, infrared, or semiconductor system, device or equipment, or any suitable combination of the above. A more specific example of the machine readable storage medium may include electrical connection based on one or more wires, portable computer disk, hard disk, RAM, ROM, EPROM, flash memory, optical fiber, CD-ROM, optical storage unit, magnetic storage unit, or any suitable combination of the above.

In a first aspect, according to one or more embodiments of the present disclosure, a remote photographing method is provided, and the remote photographing method includes:
receiving, by a first terminal, a remote photographing request used for instructing the first terminal to search for a second terminal, the second terminal being used for sending a photographing instruction to the first terminal;
determining, by the first terminal, a host internet protocol address range of the second terminal in a local area network corresponding to a wireless network or a hotspot accessed by the first terminal in response to multicast of the local area network being abnormal; and
sending, by the first terminal, a unicast message to the second terminal according to the host internet protocol address range of the second terminal, the unicast message being used for requesting acquisition of information of the second terminal in the local area network.

According to one or more embodiments of the present disclosure, the determining, by the first terminal, the host internet protocol address range of the second terminal in the local area network, includes:

determining, by the first terminal, the host internet protocol address range of the second terminal according to a local internet protocol address and a subnet mask in the local area network.

According to one or more embodiments of the present disclosure, after the sending, by the first terminal, a unicast message to the second terminal, the method further includes:
receiving, by the first terminal, a feedback message transmitted by the second terminal, the feedback message including information of the second terminal; and
updating, by the first terminal, a list of second terminals to which the first terminal is connectable according to the feedback message.

According to one or more embodiments of the present disclosure, after the updating, by the first terminal, a list of second terminals to which the first terminal is connectable according to the feedback message, the method further includes:
selecting, by the first terminal, from the list of second terminals, the second terminal that establishes a remote photographing connection with the first terminal according to indication information input by a user, the remote photographing connection being used for sharing a photographing screen of the first terminal to the second terminal and sending the photographing instruction input by the user to the first terminal through the second terminal.

According to one or more embodiments of the present disclosure, after the sending, by the first terminal, a unicast message to the second terminal, the method further includes:
in response to not receiving the feedback message sent by the second terminal within a preset duration, generating, by the first terminal, a two-dimensional code according to a local internet protocol address of the first terminal, so as to enable the second terminal to establish the remote photographing connection with the first terminal according to the local internet protocol address of the first terminal when scanning the two-dimensional code.

According to one or more embodiments of the present disclosure, before the determining, by the first terminal, the host internet protocol address range of the second terminal in the local area network corresponding to the wireless network or the hotspot accessed by the first terminal in response to the multicast of the local area network being abnormal, the method further includes:
joining and listening to the multicast by the first terminal;
determining, by the first terminal, whether the multicast is normally turned on; and
in response to the multicast being normal, sending, by the first terminal, a multicast message to the second terminal in the local area network, the multicast message being used for requesting acquisition of the information of the second terminal in the local area network.

According to one or more embodiments of the present disclosure, before the joining and listening to the multicast by the first terminal, the method further includes:
determining, by the first terminal, whether to access the wireless network or the hotspot; and
displaying, by the first terminal, prompt information on a display interface of the first terminal in response to the first terminal not accessing the wireless network or the hotspot, the prompt information being used for prompting the user to access the first terminal to the wireless network or the hotspot.

According to one or more embodiments of the present disclosure, the joining and listening to the multicast by the first terminal, includes:
in response to the first terminal accessing the wireless network or the hotspot, joining and listening to the multicast by the first terminal.

According to one or more embodiments of the present disclosure, after the receiving, by a first terminal, a remote photographing request, the method further includes:
searching, by the first terminal, for the second terminal providing a service through a multi-point connection function of a target operating system after the first terminal turns on a wireless network or a hotspot function;
receiving, by the first terminal, information of the second terminal sent by the second terminal; and
updating, by the first terminal, a list of second terminals to which the first terminal is connectable according to the information of the second terminal.

According to one or more embodiments of the present disclosure, the information of the second terminal is carried in a unicast message, a multicast message, or an additional message of the multi-point connection function.

According to one or more embodiments of the present disclosure, the list of second terminals to which the first terminal is connectable includes indication information indicating an operating system of the second terminal.

In a second aspect, according to one or more embodiments of the present disclosure, a remote photographing apparatus is provided, where the remote photographing apparatus includes:
a receiving module, for a first terminal to receive a remote photographing request used for instructing the first terminal to search for a second terminal, the second terminal being used for sending a photographing instruction to the first terminal;
a processing module, configured to determine a host internet protocol address range of the second terminal in a local area network corresponding to a wireless network or a hotspot accessed by the first terminal in response to multicast of the local area network being abnormal; and
a sending module, configured to send a unicast message to the second terminal according to the host internet protocol address range of the second terminal, the unicast message being used for requesting acquisition of information of the second terminal in the local area network.

According to one or more embodiments of the present disclosure, the processing module is further configured to determine the host internet protocol address range of the second terminal according to a local internet protocol address and a subnet mask in the local area network.

According to one or more embodiments of the present disclosure, the receiving module is further configured to receive a feedback message transmitted by the second terminal, the feedback message including information of the second terminal;

The processing module is further configured to update a list of second terminals to which the first terminal is connectable according to the feedback message.

According to one or more embodiments of the present disclosure, the processing module is further configured to select, from the list of second terminals, the second terminal that establishes a remote photographing connection with the first terminal according to indication information input by a user, the remote photographing connection being used for sharing a photographing screen of the first terminal to the second terminal and sending the photographing instruction input by the user to the first terminal through the second terminal.

According to one or more embodiments of the present disclosure, the processing module is further configured to, in response to not receiving the feedback message sent by the second terminal within a preset duration, generate a two-dimensional code according to a local internet protocol address of the first terminal, so as to enable the second terminal to establish the remote photographing connection with the first terminal according to the local internet protocol address of the first terminal when scanning the two-dimensional code.

According to one or more embodiments of the present disclosure, the processing module is further configured to join and listen to the multicast, and determine whether the multicast is normally turned on.

The sending module is further configured to, in response to the multicast being normal, send a multicast message to the second terminal in the local area network, the multicast message being used for requesting acquisition of the information of the second terminal in the local area network.

According to one or more embodiments of the present disclosure, the processing module is further configured to determine whether to access the wireless network or the hotspot, and display prompt information on a display interface of the first terminal in response to the first terminal not accessing the wireless network or the hotspot, the prompt information being used for prompting the user to access the first terminal to the wireless network or the hotspot.

According to one or more embodiments of the present disclosure, the processing module is further configured to, in response to the first terminal accessing the wireless network or the hotspot, join and listen to the multicast.

According to one or more embodiments of the present disclosure, the processing module is further configured to search for the second terminal providing a service through a multi-point connection function of a target operating system after the first terminal turns on a wireless network or a hotspot function.

The receiving module is further configured to receive information of the second terminal sent by the second terminal.

The processing module is further configured to update a list of second terminals to which the first terminal is connectable according to the information of the second terminal.

According to one or more embodiments of the present disclosure, the information of the second terminal is carried in a unicast message, a multicast message, or an additional message of the multi-point connection function.

In a third aspect, an embodiment of the present disclosure provides an electronic device, including:
a processor; and
a memory for storing a computer program;
where the processor is configured to, when executing the computer program, implement the remote photographing method as described above in the first aspect and various possible designs of the first aspect.

In a fourth aspect, an embodiment of the present disclosure provides a computer-readable storage medium storing computer execution instructions, where when the computer execution instructions are executed by a processor, the remote photographing method as described above in the first aspect and various possible designs of the first aspect is implemented.

In a fifth aspect, an embodiment of the present disclosure provides a computer program product including a computer program, where when the computer program is executed by a processor, the remote photographing method as described above in the first aspect and various possible designs of the first aspect is implemented.

In a sixth aspect, an embodiment of the present disclosure provides a computer program, where when the computer program is executed by a processor, the remote photographing method as described above in the first aspect and various possible designs of the first aspect is implemented.

The above description is only the explanation of the better embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

1. A method for remote photographing, comprising:
receiving, by a first terminal, a remote photographing request used for instructing the first terminal to search for a second terminal, the second terminal being used for sending a photographing instruction to the first terminal;
determining, by the first terminal, a host internet protocol address range of the second terminal in a local area network corresponding to a wireless network or a hotspot accessed by the first terminal in response to multicast of the local area network being abnormal; and
sending, by the first terminal, a unicast message to the second terminal according to the host internet protocol address range of the second terminal, the unicast message being used for requesting acquisition of information of the second terminal in the local area network.

2. The method according to claim 1, wherein the determining, by the first terminal, the host internet protocol address range of the second terminal in the local area network, comprises:
determining, by the first terminal, the host internet protocol address range of the second terminal according to a local internet protocol address and a subnet mask in the local area network.

3. The method according to claim 1, wherein after the sending, by the first terminal, a unicast message to the second terminal, the method further comprises:
receiving, by the first terminal, a feedback message transmitted by the second terminal, the feedback message comprising information of the second terminal; and
updating, by the first terminal, a list of second terminals to which the first terminal is connectable according to the feedback message.

4. The method according to claim 3, wherein after the updating, by the first terminal, a list of second terminals to which the first terminal is connectable according to the feedback message, the method further comprises:
selecting, by the first terminal, from the list of second terminals, the second terminal that establishes a remote photographing connection with the first terminal according to indication information input by a user, the remote photographing connection being used for sharing a photographing screen of the first terminal to the second terminal and sending the photographing instruction input by the user to the first terminal through the second terminal.

5. The method according to claim 1, wherein after the sending, by the first terminal, a unicast message to the second terminal, the method further comprises:
in response to not receiving the feedback message sent by the second terminal within a preset duration, generating, by the first terminal, a two-dimensional code according to a local internet protocol address of the first terminal, so as to enable the second terminal to establish the remote photographing connection with the first terminal according to the local internet protocol address of the first terminal when scanning the two-dimensional code.

6. The method according to claim 1, wherein before the determining, by the first terminal, the host internet protocol address range of the second terminal in the local area network corresponding to the wireless network or the hotspot accessed by the first terminal in response to the multicast of the local area network being abnormal, the method further comprises:
joining and listening to the multicast by the first terminal;
determining, by the first terminal, whether the multicast is normally turned on; and
in response to the multicast being normal, sending, by the first terminal, a multicast message to the second terminal in the local area network, the multicast message being used for requesting acquisition of the information of the second terminal in the local area network.

7. The method according to claim 6, wherein before the joining and listening to the multicast by the first terminal, the method further comprises:
determining, by the first terminal, whether to access the wireless network or the hotspot; and
displaying, by the first terminal, prompt information on a display interface of the first terminal in response to the first terminal not accessing the wireless network or the hotspot, the prompt information being used for prompting a user to access the first terminal to the wireless network or the hotspot.

8. The method according to claim 7, wherein the joining and listening to the multicast by the first terminal, comprises:
in response to the first terminal accessing the wireless network or the hotspot, joining and listening to the multicast by the first terminal.

9. The method according to claim 1, wherein after the receiving, by a first terminal, a remote photographing request, the method further comprises:
searching, by the first terminal, for the second terminal providing a service through a multi-point connection function of a target operating system after the first terminal turns on a wireless network or a hotspot function;
receiving, by the first terminal, information of the second terminal sent by the second terminal; and
updating, by the first terminal, a list of second terminals to which the first terminal is connectable according to the information of the second terminal.

10. The method according to claim 9, wherein the information of the second terminal is carried in a unicast message, a multicast message, or an additional message of the multi-point connection function.

11. The method according to claim 9, wherein the list of second terminals to which the first terminal is connectable comprises indication information indicating an operating system of the second terminal.

12. (canceled)

13. An electronic device, comprising:
a processor; and
a memory for storing a computer program;
wherein the processor is configured to, when executing the computer program, implement a method for remote photographing, wherein the method for remote photographing comprises:
receiving, by a first terminal, a remote photographing request used for instructing the first terminal to search for a second terminal, the second terminal being used for sending a photographing instruction to the first terminal;
determining, by the first terminal, a host internet protocol address range of the second terminal in a local area network corresponding to a wireless network or a hotspot accessed by the first terminal in response to multicast of the local area network being abnormal; and
sending, by the first terminal, a unicast message to the second terminal according to the host internet protocol address range of the second terminal, the unicast message being used for requesting acquisition of information of the second terminal in the local area network.

14. A computer-readable storage medium storing computer execution instructions, wherein when the computer execution instructions are executed by a processor, a method for remote photographing is implemented, wherein the method for remote photographing comprises:
receiving, by a first terminal, a remote photographing request used for instructing the first terminal to search for a second terminal, the second terminal being used for sending a photographing instruction to the first terminal;
determining, by the first terminal, a host internet protocol address range of the second terminal in a local area network corresponding to a wireless network or a hotspot accessed by the first terminal in response to multicast of the local area network being abnormal; and
sending, by the first terminal, a unicast message to the second terminal according to the host internet protocol address range of the second terminal, the unicast message being used for requesting acquisition of information of the second terminal in the local area network.

15. (canceled)

16. (canceled)

17. The electronic device according to claim 13, wherein the determining, by the first terminal, the host internet protocol address range of the second terminal in the local area network, comprises:
determining, by the first terminal, the host internet protocol address range of the second terminal according to a local internet protocol address and a subnet mask in the local area network.

18. The electronic device according to claim 13, wherein after the sending, by the first terminal, a unicast message to the second terminal, the method further comprises:
receiving, by the first terminal, a feedback message transmitted by the second terminal, the feedback message comprising information of the second terminal; and
updating, by the first terminal, a list of second terminals to which the first terminal is connectable according to the feedback message.

19. The electronic device according to claim 18, wherein after the updating, by the first terminal, a list of second terminals to which the first terminal is connectable according to the feedback message, the method further comprises:
selecting, by the first terminal, from the list of second terminals, the second terminal that establishes a remote photographing connection with the first terminal according to indication information input by a user, the remote photographing connection being used for sharing a photographing screen of the first terminal to the second terminal and sending the photographing instruction input by the user to the first terminal through the second terminal.

20. The electronic device according to claim 13, wherein after the sending, by the first terminal, a unicast message to the second terminal, the method further comprises:
in response to not receiving the feedback message sent by the second terminal within a preset duration, generating, by the first terminal, a two-dimensional code according to a local internet protocol address of the first terminal, so as to enable the second terminal to establish the remote photographing connection with the first terminal according to the local internet protocol address of the first terminal when scanning the two-dimensional code.

21. The electronic device according to claim 13, wherein before the determining, by the first terminal, the host internet protocol address range of the second terminal in the local area network corresponding to the wireless network or the hotspot accessed by the first terminal in response to the multicast of the local area network being abnormal, the method further comprises:
joining and listening to the multicast by the first terminal;
determining, by the first terminal, whether the multicast is normally turned on; and
in response to the multicast being normal, sending, by the first terminal, a multicast message to the second terminal in the local area network, the multicast message being used for requesting acquisition of the information of the second terminal in the local area network.

22. The electronic device according to claim 21, wherein before the joining and listening to the multicast by the first terminal, the method further comprises:
determining, by the first terminal, whether to access the wireless network or the hotspot; and
displaying, by the first terminal, prompt information on a display interface of the first terminal in response to the first terminal not accessing the wireless network or the hotspot, the prompt information being used for prompting a user to access the first terminal to the wireless network or the hotspot.

23. The electronic device according to claim 22, wherein the joining and listening to the multicast by the first terminal, comprises:
in response to the first terminal accessing the wireless network or the hotspot, joining and listening to the multicast by the first terminal.
